(19) United States
(12) Patent Application Publication
(10) Pub. No.: US 2012/0189882 A1
(43) Pub. Date: Jul. 26, 2012

(54) BATTERY

(75) Inventors: Tomoyoshi Kurahashi, Tokyo (JP); Yoshihide Kurahashi, Tokushima-shi (JP)

(73) Assignee: MITSUBISHI HEAVY INDUSTRIES, LTD., Tokyo (JP)

(21) Appl. No.: 13/354,662

(22) Filed: Jan. 20, 2012

(30) Foreign Application Priority Data
Jan. 24, 2011 (JP) 2011-011486

(51) Int. Cl. H01M 2/38; H01M 2/20; H01M 2/18

(52) U.S. Cl. 429/81

(57) ABSTRACT

A battery includes a stacked electrode body which is formed by stacking sequentially a first electrode plate connected to a first electrode tab, a separator, and a second electrode plate connected to a second electrode tab; an electrolyte; a battery case which seals the stacked electrode body and the electrolyte; and a guidance structure which guides the electrolyte, which moves inside the battery case due to heat generated by the stacked electrode body, to a direction inclined from a direction of gravitational force and also guides the electrolyte to the first or the second electrode tab.

### BACKGROUND OF THE INVENTION

1. Field of the Invention

The present invention relates to a battery and, in particular, to a battery having the improved heat dissipation properties.

Priority is claimed on Japanese Patent Application No. 2011-011486, filed on Jan. 24, 2011, the content of which is incorporated herein by reference.

2. Description of Related Art

A battery includes a primary battery that may be only discharged and a secondary battery that may be both charged and discharged. These batteries have a configuration in which a battery case hermetically seals a stacked electrode body together with an electrolyte. The stacked electrode is formed by stacking electrode plates, that is, a cathode plate and an anode plate with a separator interposed between them. These batteries are generally used to supply electricity for driving the electricity load such as a motor in a battery system.

These batteries discharge by migration of ions between the cathode plate and the anode plate via the electrolyte. Thus, it is important to provide sufficiently the electrolyte between the cathode plate and the anode plate in view of improving the performance of the batteries.

Here, it is reported that a structure in which a plurality of grooves are formed on the surface of electrode plates of a battery to attain sufficient infiltration of an electrolyte between the electrode plates in order to improve the performance of the battery (refer to Japanese Patent Application Laid-Open No. H11-154508).

However, for example, when the above-described battery discharges, the stacked electrode body may generate heat to result in high temperature, furthermore, the battery case itself may become the high temperature in general.

When the stacked electrode body becomes the high temperature, an electrode active material is degraded to result in possible battery failure and deterioration in performance of the battery. Additionally, when the battery case itself becomes the high temperature, other devices in the battery system in which the battery is arranged may be adversely affected by this action.

### SUMMARY OF THE INVENTION

The present invention provides a battery which is excellent in performance being improved in heat dissipation properties with attaining sufficient infiltration of an electrolyte between electrode plates of the battery.

In order to attain the above-described object, a battery according to one aspect of the present invention includes: a stacked electrode body which is formed by stacking sequentially a first electrode plate connected to a first electrode tab, a separator, and a second electrode plate connected to a second electrode tab; an electrolyte; a battery case which seals the stacked electrode body and the electrolyte; and a guidance structure which guides the electrolyte, which moves inside the battery case due to heat generated by the stacked electrode body, to a direction inclined from a direction of gravitational force and also guides the electrolyte to the first or the second electrode tab.

That is, because an electrolyte, that causes convection inside a battery case due to heat generated by a stacked electrode body, is guided to an electrode tab which is particularly increased in temperature, it is possible to effectively promote heat exchange not only between electrode plates but also between the electrode tab and the electrolyte. Therefore, the battery can be improved in heat dissipation properties to result in improved performance of the battery.

According to the aspect of the present invention, it is possible to provide a battery which has excellent in performance being improved in heat dissipation properties with attaining sufficient infiltration of an electrolyte into electrode plates.

### BRIEF DESCRIPTION OF THE DRAWINGS

FIG. 1A is a schematic view which shows a battery of an embodiment of the present invention and also a perspective schematic view of the battery showing the front side of the battery.

FIG. 1B is a schematic view which shows the battery of the embodiment of the present invention and also a cross-sectional schematic view taken along the line of A to A′ in FIG. 1A.

FIG. 2A is a schematic view which shows an arrangement of grooves on the surface of an electrode plate of the battery in FIG. 1.

FIG. 2B is a detailed view which describes grooves which are arranged at a certain angle with respect to the Z axis, among the grooves shown in FIG. 2A.

FIG. 3 is a schematic view which shows a modified example of the arrangement of grooves on the surface of the electrode plate of the battery shown in FIG. 1A or FIG. 1B.

FIG. 4 is a schematic view which shows an arrangement of grooves on the surface of a separator of the battery shown in FIG. 1A or FIG. 1B.

FIG. 5 is a schematic view which shows fusion sites when the separator of the battery shown in FIG. 1A or FIG. 1B is given as a bag-shaped separator.

### DETAILED DESCRIPTION OF THE INVENTION

A battery according to embodiments of the present invention includes a structure in which an electrolyte, which causes convection inside a battery case due to heat generated by a stacked electrode body, is guided to a direction inclined from a direction of gravitational force and also guided and allowed to flow to an electrode tab formed integrally with an electrode plate (i.e., a cathode plate or an anode plate). Thereby, one feature of the battery is to promote effectively heat exchange between the electrolyte and the electrode tab which is confirmed to be a particularly-high temperature on heat generation of the stacked electrode body. Hereinafter, a detailed description will be made with reference to the drawings.

Any one of primary batteries and secondary batteries may be used as the battery of the embodiment. However, here, a battery capable of charging and discharging, for example, a lithium ion secondary battery as a storage battery will be described as one example of the batteries.

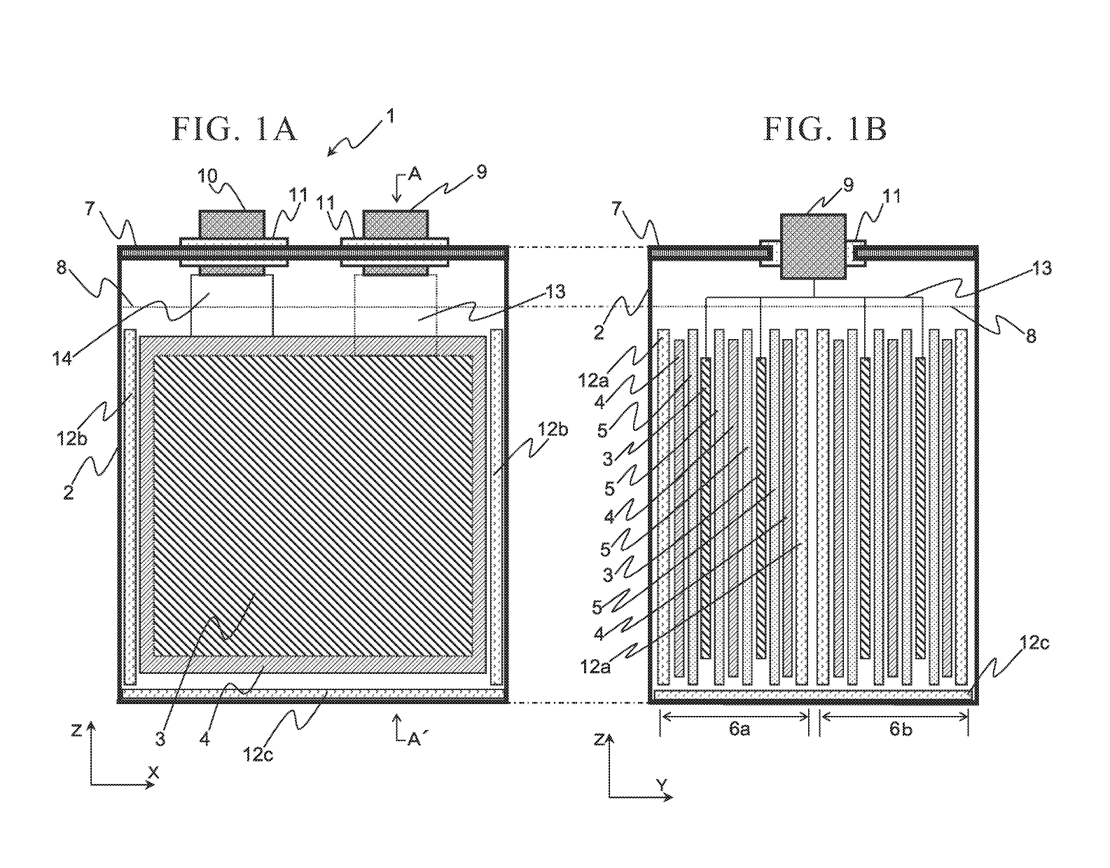

Hereinafter, a battery 1 of the present embodiment will be described by referring to FIG. 1A to FIG. 5. It is noted that the same XYZ orthogonal coordinate system is used in all of these figures.

First, a brief configuration of the battery 1 will be described by referring to FIG. 1A and FIG. 1B. FIG. 1A is a perspective schematic view of the battery 1 showing the front side of the battery 1 (on an XZ plane). FIG. 1B is a cross-sectional schematic view on an YZ plane taken along the line A to A′ given in FIG. 1A. Because FIG. 1A is a schematic view of the battery 1 for giving a better understanding, therefore, not all the components are shown in FIG. 1B are shown in FIG. 1A.

The battery 1 includes a container main body 2, a stacked electrode body, and a cover 7. The container main body 2 is a square conductive material (e.g. a metal such as aluminum) having a substantially rectangular bottom on an XY plane and also having wall surfaces extending to the Z axis direction from all sides of the substantially rectangular bottom. The stacked electrode body is stored in the container main body 2 and is formed by stacking a cathode plate 3 and an anode plate 4 with a separator 5 interposed between them. A unit in which the stacked electrode body is held between a pair of insulating resin plate 12a and insulating resin plate 12b to be described below is referred to as a battery block 6. Here, two battery blocks 6a, 6b which have the same components are arranged. The cover 7 hermetically seals the container main body 2 after the battery blocks 6 are stored in the container main body 2 (hereinafter, a battery case is obtained by hermetically sealing the container main body 2 and the cover 7). Although an electrolyte is not shown, the electrolyte is stored at the battery case. In order that the entire faces of the two electrode plates, that is, the cathode plate 3 and the anode plate 4, are completely submerged into the electrolyte, a fluid level 8 of the electrolyte is designed to be positioned away from the entire faces of the two electrode plates to the +Z direction.

The cover 7 is made of a conductive material which is the same as the container main body 2. Then, the cover 7 includes cylindrical electrode terminals (i.e., a cathode terminal 9 and an anode terminal 10), each of that has the cross section on the XY plane is substantially a circle with a diameter of “r”, arranged so as to penetrate through the cover 7, and an insulating resin 11 (e.g. a plastic resin or the like) for fixing each of the electrode terminals to the cover 7 to electrically insulate the electrode terminals and the cover 7. As described above, because the battery case has conductivity, the battery block 6 and the battery case need to be electrically insulated from each other. For this reason, on an inner bottom of the container main body 2, an insulating resin plate 12c (e.g. a plastic-resin plate or sheet) is arranged, which is substantially identical to the bottom in shape and size.

Further, for the purpose of preventing deterioration in performance of the battery, a conductive part having high resistance (not shown) is arranged in order that a potential of the battery case is changed to a positive potential or a negative potential of the battery 1, corresponding to the materials of the active material and others of the stacked electrode body. Here, because the materials of the active material and others of the stacked electrode body are as described below, the conductive part is connected between the cathode terminal 9 and the cover 7 to form a conductive channel between the cathode terminal 9 and the battery case in order that the battery case has a positive potential.

As an example, the stacked electrode body of the battery block 6 is an electrode body which is a stacked-type. That is, there are a plurality of cathode plates 3, a plurality of anode plates 4 and separators 5, and the cathode plate 3 and the anode plates 4 is stacked with the separator 5 interposed between them.

The cathode plate 3 is formed by coating a cathode active material such as lithium manganate on both faces of a cathode metallic foil such as aluminum, and by punching out the cathode metallic foil in a substantially rectangular shape. In the punching process, a cathode metallic foil, which is not coated with the cathode active material, is also punched out together with the cathode plate 3, and the section of cathode metal foil punched out is given as a cathode tab 13 connected to the cathode plate 3. Here, the shape of the cathode tab 13 is a substantially rectangular shape when an XZ plane is viewed from the Y direction and is designed to be smaller in size in the X direction than the cathode plate 3 in the X direction.

On the other hand, the anode plate 4 is formed by coating an anode active material such as carbon on the both faces of an anode metallic foil such as copper, and by punching out the anode metallic foil in a substantially rectangular shape. In the punching process, an anode metal foil, which is not coated with the anode active material, is also punched out together with the anode plate 4, and the section of anode metallic foil is given as an anode tab 14 connected to the anode plate 4. Here, the shape of the anode tab 14 is a substantially rectangular shape when the XZ plane is viewed from the Y direction and is designed to be smaller in size in the X direction than the anode plate 4 in the X direction.

The size of the substantially rectangular shape on the XZ plane of the anode plate 4 has such a size that it can be stored inside the battery case without being bent. The size of the substantially rectangular shape on the XZ plane of the cathode plate 3 is smaller than the size of the substantially rectangular shape on the XZ plane of the anode plate 4. Therefore, as shown in FIG. 1A, the cathode plate 3 is arranged inside a plane of the anode plate 4, when viewed from the Y direction. Further, the anode tab 14 is arranged at such a position that does not overlap with the cathode tab 13 on the XZ plane, when the cathode plate 3 and the anode plate 4 are stacked in the Y direction, as described below.

The separator 5 is a separator which is formed substantially in a rectangular shape for batteries, for example, a ceramic separator. The size of the substantially rectangular shape on the XZ plane of the separator 5 is designed to be larger than the size of the substantially rectangular shape on the XZ plane of the anode plate 4.

One of the anode plates 4 that have sizes larger than those of the cathode plates 3 starts to be stacked, and the separator 5 is arranged on the one of the anode plates 4 (to the +Y direction). One of the cathode plates 3 is stacked on the separator 5 (to the +Y direction). Further, the separator 5 is arranged on the cathode plate 3 (to the +Y direction) and another of the anode plates 4 is stacked on the separator 5 (to the +Y direction). In this instance, the plurality of anode plates 4 is stacked in order that the anode tabs 14 are arranged at the same position in the XZ plane.

The above-described procedure is sequentially repeated. As a result, a stacked electrode body is formed which is made up of the plurality of cathode plates 3 and the plurality of anode plates 4 and in which an anode plate 4 is arranged at both ends in the Y direction, when it is viewed from the X direction.

Then, the stacked electrode body is pressed from both the +Y direction and the −Y direction, and held between a pair of insulating resin plates 12a. Further, the stacked electrode body is held between a pair of insulation resin plates 12b from both the +X direction and a −X direction. The mutually adjacent insulating resin plates 12a and 12b are fixed by using an insulation tape, thereby forming a battery block 6 as one unit. Each of the insulating resin plates 12a and 12b is, for example, a resilient and thick plastic resin plate. Because the stacked electrode body is sandwiched by and between the insulation resin plates and fixed as described above, the electrode plates of the stacked electrode body are not protruded from in-plane areas of the insulation resin plates 12a and the insulation resin plates 12b. The stacked electrode body is inserted into the container main body 2 as a battery unit which is held between the insulation resin plates 12a and the insulation resin plates 12b. Thereby, because these resin plates are in contact with the container main body 2, it is possible to prevent the stacked electrode body from being damaged at the time of insertion.

The size of the substantially rectangular shape on the XZ plane of the insulating resin plate 12a is substantially equal to or slightly larger than the size of the anode plate 4 on the XZ plane. Further, In terms of the size of the substantially rectangular shape on the YZ plane of the insulating resin plate 12b, the size of the insulating resin plate 12b in the Z direction is equal to the size of the insulating resin plate 12a in the Z direction. And, the size of the insulating resin plate 12b in the Y direction is designed to be substantially equal to or slightly larger than the size of the stacked electrode body in the Y direction which constitutes the battery block 6 and is in a pressed state as described above.

Still further, a plurality of through holes (not shown) are formed on the insulating resin plates 12a and the insulating resin plates 12b in order to promote infiltration of an electrolyte into the stacked electrode body.

All the cathode tabs 13, which are positioned so as to be substantially in alignment when they are viewed from the Y direction, are electrically connected to the cathode terminal 9 by riveting, welding or other methods. In this instance, the cathode tab 13 may be directly connected to the cathode terminal 9. A metallic cathode lead may be interposed between the cathode tab 13 and the cathode terminal 9. All the anode tabs 14, which are positioned so as to be substantially in alignment when they are viewed from the Y direction, are electrically connected to the anode terminal 10 by riveting, welding or other methods. In this instance, the anode tab 14 may be directly connected to the anode terminal 10. A metallic anode lead may be interposed between the anode tab 14 and the anode terminal 10.

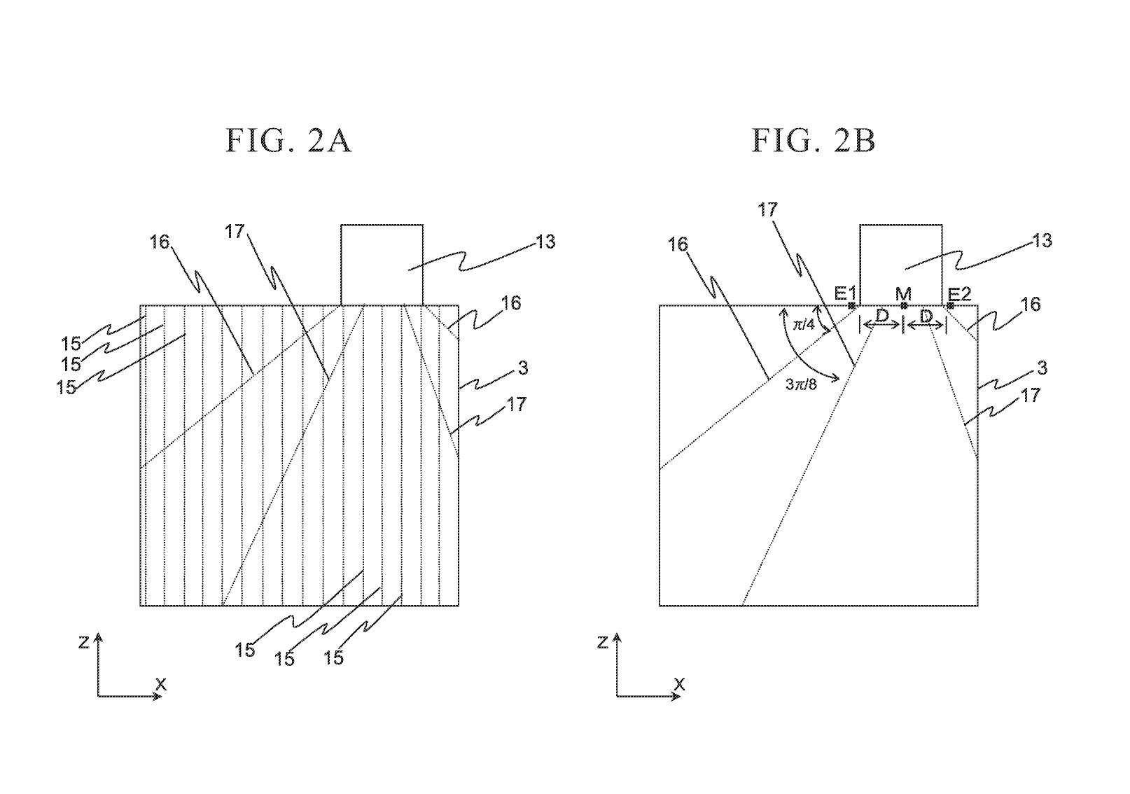

Next, with reference to FIG. 2 to FIG. 5, the above-described “structure” in which an electrolyte flowing inside the battery case by convection due to heat generated by the stacked electrode body, is guided to a direction inclined from a direction of gravitational force and also guided and allowed to flow to an electrode tab integrally formed with an electrode plate (i.e. a cathode plate or a anode plate)” (hereinafter, referred to as a “guidance structure”).

As the guidance structure, there are a first guidance structure installed on an electrode plate, and a second guidance structure and a third guidance structure installed on a separator. Only any one of these guidance structures may be arranged on the battery 1. In case that further improvement in heat dissipation properties is required, two or all of these guidance structures may be arranged at the same time on the battery 1.

The above-described convection occurs when the stacked electrode body inside the battery case generates heat due to charge or discharge of the battery 1 and when the temperature inside of the battery case becomes greater than the temperature outside of the battery case, while the battery case is cooled externally at an ordinary temperature or by an air cooling device, etc. More specifically, when an electrolyte is heated up near the center of the battery case, the electrolyte flows so as to rise to the +Z direction, regarding the direction of gravitational force (i.e., the Z axis direction). And, when the electrolyte is cooled near wall surfaces of the battery case, the electrolyte flows so as to descend to the −Z direction. Thereby, the electrolyte circulates inside the battery case to cause convection.

First, the first guidance structure will be described. FIG. 2A is a schematic view which shows an arrangement of grooves on the surface of an electrode plate of the battery shown in FIG. 1 (here, as an example, an arrangement of grooves on the surface of the cathode plate 3 is shown). Further, FIG. 2B is a detailed view which describes, in particular, grooves as the first guidance structures, among the grooves shown in FIG. 2A.

As shown in FIG. 2A, a plurality of vertical grooves 15 extending from one end to the other end of the cathode plate 3 in the Z axis direction and a plurality of grooves 16, 17 as the first guidance structures are formed on the surface of a cathode active material of the cathode plate 3.

The plurality of vertical grooves 15 is able to promote infiltration of the electrolyte into the cathode plate 3 and also works as flow channels for an electrolyte to move in the +Z direction naturally, when an electrolyte in the vicinity of the cathode plate 3 is heated up by heat generated at the cathode plate 3. Here, the Z axis direction is given as the direction of gravitational force.

As described above, the stacked electrode body of the battery block 6 is pressed. Therefore, the flow channels play an important role in dissipating the heat generated at the cathode plate 3 substantially evenly on the entire surface of the cathode plate 3 by utilizing convection of the electrolyte. For the purpose of attaining substantially even heat dissipation, the plurality of vertical grooves 15 is designed so as to be spaced from each other at a substantially equal interval.

As shown in FIG. 2B, the groove 16 (here, referred to as “a reference groove 16”) as a first guidance structure is a groove extending from an end E1 to a side of the cathode plate which is one of two sides of the cathode plate on the X axis and which is existed to the −X direction, at an angle of about 45° (i.e., π/4 radian) to the side, although the end E1 is an end of two ends of the cathode tab 13 that are existed on the side of the cathode plate where the cathode tab and the cathode plate are connected and which is existed to the −X direction. Or the reference groove 16 is a groove extending from an end E2 to a side of the cathode plate which is one of two sides of the cathode plate on the X axis and which is existed to the +X direction, at an angle of about 45° (i.e., π/4 radian) to the side, although the end E2 is the other end of the two ends of the cathode tab 13.

In case that the groove is formed at an angle smaller than angle of about 45°, the electrolyte may not be smoothly guided. Therefore, the groove which is formed at an angle of about 45° is used as a reference groove in forming the groove 17 to be described below.

Similarly, the groove 17 as a first guidance structure (here, referred to as “a θn groove 17”) is a groove formed between the reference groove 16 and a virtual line extending in the −Z direction from a middle point M between the two ends of the cathode tab 13 on the side extending in the X axis direction of the cathode plate 3 where the cathode plate 3 is connected to the cathode tab 13.

When the θn grooves 17 are formed in the number of “m” (“m” is a positive integer) between the end E1 and the middle point M (excluding the end E1 and the middle point M), by using the length D of a line connecting between the end E1 and the middle point M, an n-th groove (however, n≦m) is formed from a position spaced away on the line only by {D/(m+1)}×n from the end E1 toward the middle point M to the side of two sides existed on the X axis direction of the cathode plate 3, at an acute angle of θn radian to the line, that is, θn=(π/4)+{π/(4×(m+1))}×n.

Similarly, when the θn groves 17 are formed in the number of “m” (“m” is a positive integer) between the end E2 and the middle point M (excluding the end E2 and the middle point M), by using the length D of a line connecting between end E2 and the middle point M, an n-th groove (however, n≦m) is formed from a position spaced away on the line only by {D/(m+1)}×n from the end E2 toward the middle point M to the side of two sides existed on the X axis direction of the cathode plate 3, at an acute angle of θn radian to the line, that is, θn=(π/4)+{π/(4×(m+1))}×n.

In FIG. 2, because m is set to be equal to 1, a θ1 groove 17 is formed at an angle of θ1=(3π/8) radian. In case that m is equal to 2, 3, . . . , the θ1 groove, . . . , a θm groove are formed according to the above rule.

The reference groove 16 and the θn groove 17 as the first guidance structures have functions not only to promote infiltration of an electrolyte into the cathode plate 3, as with the plurality of vertical grooves 15, but also to work as flow channels through which the electrolyte is guided and allowed to flow to the cathode tab 13 which becomes high temperature than the cathode plate 3 because of the electric current is concentrated.

The reference groove 16 and the θn groove 17, which are flow channels through which the electrolyte is guided and allowed to flow to the cathode tab 13, are formed at an acute angle of about 45° or smaller in the direction of gravitational force (the Z axis direction). As a result, when the electrolyte, which is increased in temperature by heat generated at the cathode plate 3, rises naturally to the +Z direction toward the cover 7 of the battery case, some of the electrolyte is smoothly guided to the cathode tab 13 along the flow channels of the reference groove 16 and the θn groove 17. Therefore, the flow rate of the electrolyte can be increased in the vicinity of the cathode tab 13 to enhance the flow thereof. Thus, the electrolyte which has drawn heat from the cathode tab 13 can be immediately sent out to the vicinity of the wall surfaces of the battery case without staying in the vicinity of the cathode tab 13. As a result, it is possible to improve heat dissipation properties of the battery 1.

For example, the vertical grooves 15 as well as the reference groove 16 and the θn groove 17 as the first guidance structures can be formed by using a punching device. The punching device is used to punch out a cathode metallic foil on which a cathode active material is coated to form the cathode plate 3 and the cathode tab 13 at the same time by a mold, and has convex parts corresponding to the above grooves, that are arranged on a sponge to press the cathode plate, although the sponge is included in the mold includes as well as a Thomson blade for carrying out a punching process and others. That is, the above grooves are formed by pressing the cathode active material by the sponge appropriately to put a dent on the cathode active material. Of course, after the punching process, the grooves may be formed separately by a pressing process or may be formed by a cutting process.

The grooves can be formed on the anode plate 4 in a similar manner.

Here, the thickness of the electrode active material in the Y direction is approximately from 40 nm to 100 nm in all of the electrode plates. Therefore, the depth of each of the grooves in the Y direction is made to be approximately from 5 nm to 10 nm, by which the grooves can function sufficiently as the above-described flow channels.

In FIG. 2, a description has been made by exemplifying the cathode plate 3 and the cathode tab 13 for the vertical grooves 15 as well as the reference groove 16 and the On groove 17 as the first guidance structures. The vertical grooves 15 as well as the reference groove 16 and the On groove 17 as the first guidance structures can be arranged similarly on the anode plate 4 and the anode tab 14.

Therefore, depending on the specification of the battery 1, these grooves may be formed on both the cathode plate 3 and the anode plate 4. Alternatively, the grooves may be formed on only one of the electrode plates.

The number m of θn grooves 17 is determined by considering heat dissipation properties required for the battery 1 appropriately.

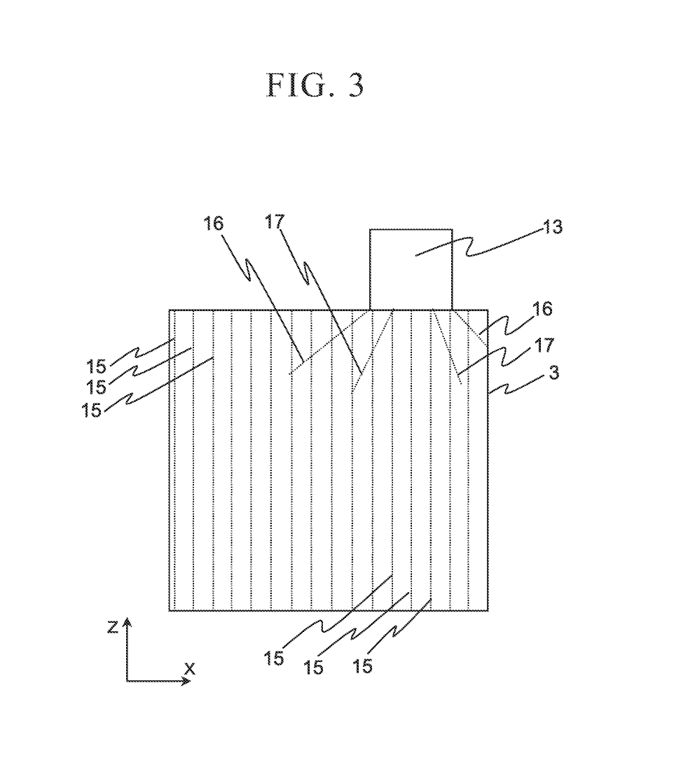

Further, depending on the heat dissipation properties required for the battery 1, there is a case that an electrolyte is only guided to the electrode tab. In this regard, there is also available such a constitution that at least the θn groove 17 may be arranged. In light of the above viewpoint as shown in the modified example in FIG. 3, the length of each of the grooves as the first guidance structure can be designed to be shorter than the example shown in FIG. 2.

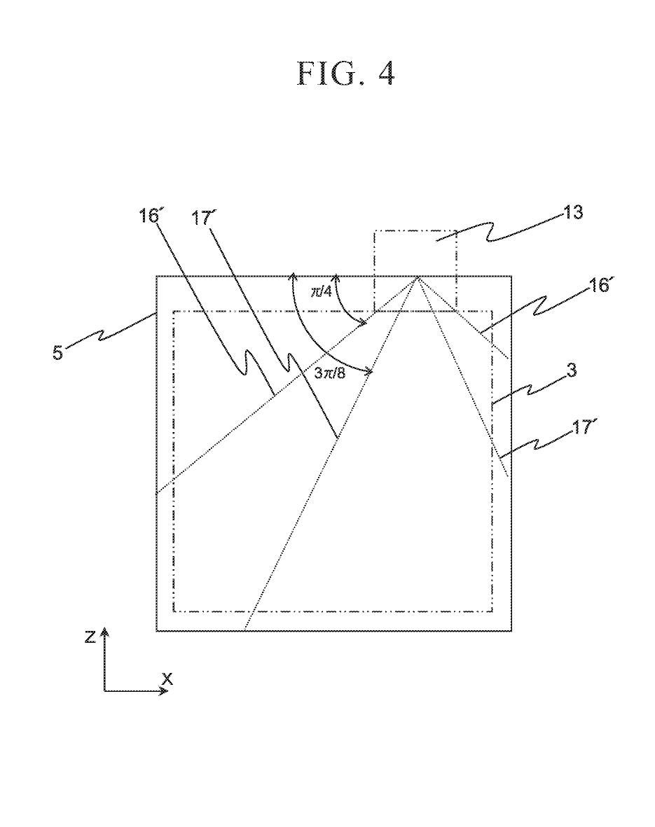

Next, a second guidance structure will be described. FIG. 4 is a schematic view which shows an arrangement of grooves on the surface of the separator 5 of the battery in FIG. 1, as the second guidance structure. In FIG. 4, for simplifying the description, positions at which the cathode plate 3 and the cathode tab 13 are to be arranged when the XZ plane of the separator 5 is viewed from the Y direction are indicated with alternate long and two short dashed lines.

In FIG. 4, a reference groove 16′ which corresponds positionally to the reference groove 16 shown in FIG. 2 on a one-to-one basis, and a θn groove 17′ which corresponds positionally to the θn groove 17 shown in FIG. 2 on a one-to-one basis, are formed on a part of the surface of the separator 5 which is in contact with the cathode plate 3. A rule for forming the reference groove 16′ and the θn groove 17′ is the same as a rule for arranging the above-described reference groove 16 and the θn groove 17 which is applicable to the cathode plate 3, on the assumption that the scheduled positions, indicated with the alternate long and two short dashed lines at which the cathode plate 3 and the cathode tab 13 are to be arranged, are actual positions of the cathode plate 3 and the cathode tab 13.

However, the length of the reference groove 16′ and the length of the θn groove 17′ may be formed outside the scheduled positions at which they are to be arranged, as shown in FIG. 4. There is a case that the cathode plate 3 is arranged slightly away from the scheduled position when the cathode plate 3 is actually stacked on the separator 5. This is because some of the electrolyte moving to the +Z direction is reliably guided to the vicinity of the cathode tab 13, even when the cathode plate 3 is arranged away from the position.

In FIG. 4, a description has been made for a case that the reference groove 16′ and the θn groove 17′ as the second guidance structures are formed on one face of the separator 5 by using the scheduled positions at which the cathode plate 3 and the cathode tab 13 are to be arranged. However, because the anode plate 4 is stacked on the other face of the separator 5, the reference groove 16′ and the θn groove 17′ as the second guidance structures corresponding to the anode plate 4 may also be formed on the other face of separator 5.

Further, when the separator 5 is a ceramic separator, the ceramic may be cut out appropriately to form the reference groove 16′ and the θn groove 17′. When the separator 5 is an insulation resin separator, these grooves may be formed by molding. Because the thickness of the separator 5 (in the Y direction) is about 20 μm, the depth of each of these grooves (in the Y direction) is made to be approximately from 5 μm to 10 μm, by which the grooves can function sufficiently as flow channels.

According to the second guidance structure, as with the first guidance structure, the flow rate of the electrolyte in the vicinity of the electrode tab can be increased and the flow of the electrolyte can be enhanced. Thus, the electrolyte which has drawn heat from the electrode tab can be immediately sent out to the vicinity of the wall surfaces of the battery case without staying in the vicinity of the electrode tab. As a result, it is possible to improve heat dissipation properties of the battery 1.

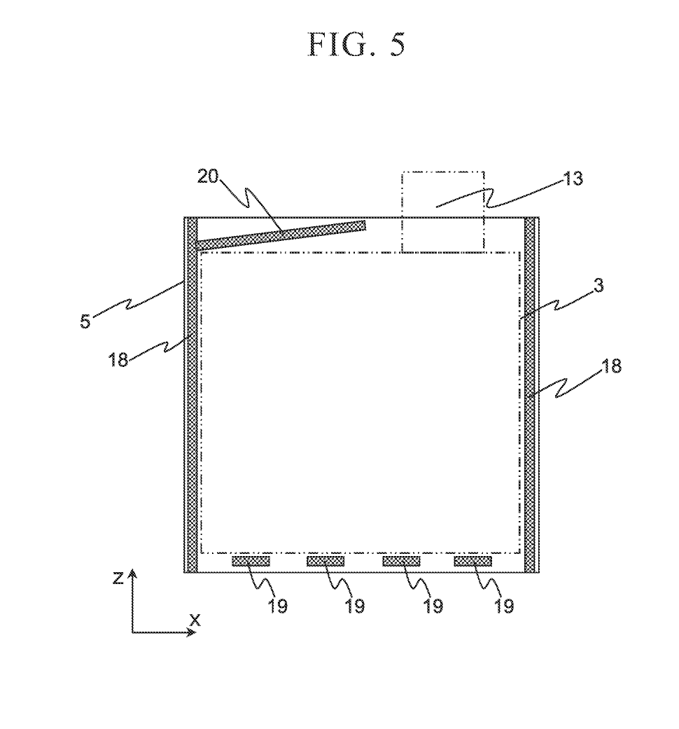

Finally, a third guidance structure will be described. The third guidance structure is a structure which can be applied to a case that mutually opposing sides of any two adjacent separators 5 shown in FIG. 1A and FIG. 1B are heat-melted and bonded together (referred to as fusion) to form a bag-shaped separator. FIG. 5 shows an example when the cathode plate 3 is enclosed in the bag-shaped separator. The enclosed cathode plate 3 is indicated with the alternate long and two short dashed lines in the drawing. Furthermore, a state that an electrode plate (a cathode plate 3 or an anode plate 4) is entirely stored inside the bag-shaped separator and that an electrode tab (a cathode tab 13 or an anode tab 14) protrudes out of the bag is referred to as “enclosing.”

As shown in FIG. 5, the bag-shaped separator, which is made by fusing two separators 5, includes the third guidance structure. At least, the third guidance structure includes a first fusion part 18 in which the vicinity of each of the two sides on the X axis is fused in the Z direction with substantially no leakage when the XZ plane is viewed from the Y direction, a second fusion part 19 in which the vicinity of the side in the −Z direction, of two sides on the Z axis, is fused, with a space (this space is not fused) kept at a predetermined interval (for example, about 10 mm) whenever necessary, and a third fusion part 20 which is fused at a certain inclination from the Z axis toward the vicinity of the cathode tab 13. One end of the third fusion part 20 is connected to the first fusion part 18 and the other end of the third fusion part 20 is formed around the electrode tab, and the other end is located to the +Z direction from the one end.

Because the fusion is carried out as described above, an electrolyte increased in temperature by heat generated at the cathode plate 3 rises naturally toward the cover 7 of the battery case in the +Z direction to cause convection. Thereby, a low-temperature electrolyte, which has entered inside the bag-shaped separator from the vicinity of the bottom of the battery case through the spaces between the plurality of second fusion parts 19, rises inside the bag to the +Z direction with substantially no leakage by each of the first fusion parts 18, and withdraws heat from the cathode plate 3. Further, the electrolyte is smoothly guided by the third fusion part 20 to the vicinity of the cathode tab 13, without staying inside the bag, and goes out of the bag from a part which is not fused in the vicinity of the cathode tab 13.

Therefore, the flow rate of the electrolyte can be increased in the vicinity of the cathode tab 13 to enhance the flow thereof. Thereby, the electrolyte which has drawn heat from the cathode tab 13 can be immediately sent out to the vicinity of the wall surfaces of the battery case without staying in the vicinity of the cathode tab 13. As a result, it is possible to improve heat dissipation properties of the battery 1. In this instance, since the cathode plate 3 is sufficiently submerged into the electrolyte, it is also possible to improve the performance of the battery.

In FIG. 5, the cathode plate 3 is enclosed inside the bag-shaped separator. However, the anode plate 4 may be enclosed inside the bag-shaped separator.

Further, the first fusion part 18 is not necessarily a single line continuing from one end to the other end of the separator 5 as shown in FIG. 5, as long as the electrolyte is allowed to rise to the +Z direction with substantially no leakage. That is, The first fusion part 18 may be formed in such a shape that open spaces are provided partially between fusion parts, as shown in the plurality of second fusion parts 19 (a dot-like shape). The third fusion part 20 is not necessarily a continuous single line as shown in FIG. 5, as long as the electrolyte can be smoothly guided to the vicinity of the cathode tab 13. That is, the third fusion part 20 may be formed in a dot-like shape in which open spaces are provided partially between fusion parts, as shown in the plurality of second fusion parts 19.

As described above, because the battery of the present embodiment includes the first to the third guidance structures, it is possible to provide a battery which has excellent in performance being improved in heat dissipation of heat generated inside the battery case, in particular, heat dissipation properties of an electrode tab.

The present invention is not limited to the above-described embodiments but may be modified in various ways without departing from the spirit or scope of the present invention. For example, although the shape of the battery case is described as a square battery case, the battery case may be a cylindrical shape. Similarly, the stacked electrode body 6 may be a stacked electrode body (i.e. a stacked-type stacked electrode body) in which a plurality of cathode plates and a plurality of anode plates are sequentially stacked with separators in between or may be a stacked electrode body (i.e. a winding-type stacked electrode body) in which one cathode plate and one anode plate with one separator interposed between them and in which they are wound. In case that the stacked electrode body 6 is a stacking-type stacked electrode body, the number of the cathode plates 3 and the anode plates 4 may be designed to be more than one, that is, any appropriate plural number.

Further, the battery unit may be designed to be any number, that is, one or three or more.

Still further, in the above-described embodiment, the battery case has been described as a conductive material which has high effect of heat dissipation, but the battery case may be formed from an insulating resin such as a plastic depending.

What is claimed is:

1. A battery comprising:
a stacked electrode body which is formed by stacking sequentially a first electrode plate connected to a first electrode tab, a separator, and a second electrode plate connected to a second electrode tab;
an electrolyte;
a battery case which seals the stacked electrode body and the electrolyte; and
a guidance structure which guides the electrolyte, which moves inside the battery case due to heat generated by the stacked electrode body, to a direction inclined from a direction of gravitational force and also guides the electrolyte to the first or the second electrode tab.

2. The battery according to claim 1, wherein
the guidance structure is a groove formed on the first or the second electrode plate.

3. The battery according to claim 1, wherein
the guidance structure is a groove formed on the separator.

4. The battery according to claim 1, wherein
the separator is a bag-shaped separator which encloses the first electrode plate, and the guidance structure is formed at a fusion part of the bag-shaped separator.

5. The battery according to claim 1, wherein
the first electrode plate is a cathode plate, the second electrode plate is an anode plate, the first electrode tab is a cathode tab, and the second electrode tab is an anode tab.

6. The battery according to claim 2, wherein
the first electrode plate is a cathode plate, the second electrode plate is an anode plate, the first electrode tab is a cathode tab, and the second electrode tab is an anode tab.

7. The battery according to claim 3, wherein
the first electrode plate is a cathode plate, the second electrode plate is an anode plate, the first electrode tab is a cathode tab, and the second electrode tab is an anode tab.

8. The battery according to claim 4, wherein
the first electrode plate is a cathode plate, the second electrode plate is an anode plate, the first electrode tab is a cathode tab, and the second electrode tab is an anode tab.
